(19) United States
(12) Patent Application Publication
(10) Pub. No.: US 2005/0096573 A1
(43) Pub. Date: May 5, 2005

(54) Non-electrical driven dental hygiene pulsating sprayer

(76) Inventor: Michael C. Liu, Feng Yuan City (TW)

Correspondence Address: Jackson Walker L.L.P., Suite 2100, 112 E. Pecan Street, San Antonio, TX, 78205, US

(21) Appl. No.: 10/696,157

(22) Filed: Oct. 29, 2003

(51) Int. Cl. A61H 9/00

(52) U.S. Cl. 601/162; 601/165

(57) ABSTRACT

A pulsating dental sprayer has a body and a turbine rotor. The body is adapted to connect to a water source and has a handle and a spraying head. The turbine rotor is rotatably received in the body and has a semicircular ring, a semicircular top plate and multiple extension blades. The semicircular top cover is attached to the ring to construct a circle in cooperation with the semicircular ring. The extension blades are formed on and extend radially from the outer periphery of the ring and the top cover. Accordingly, the sprayer can provide a pulsating massage effect, and electrical power is not needed for use of the sprayer.

### BACKGROIND OF THE INVENTION

1. Field of the Invention

The present invention relates to a sprayer, and more particularly to a dental hygiene pulsating sprayer that can provide a pulsating massage effect and is not driven by electrical power.

2. Description of Related Art

To clean teeth, a toothbrush is always used with toothpaste. However, the conventional toothbrush is inconvenient in use, and the user, especially a child, cannot sufficiently clean teeth with a conventional toothbrush. Therefore, a teeth sprayer is provided to spray water for cleaning teeth of a user. A conventional teeth sprayer substantially comprises a handle with a head and a pump. The head is mounted on one end of the handle. The handle is connected at its other end to a water source through a hose. The pump is used to pump the water to spray out from the head of the handle, and the sprayed water can be used to efficiently clean teeth of a user.

However, the conventional teeth sprayer needs electrical power to drive the pump to work, so a high cost is involved in using the conventional teeth sprayer. That is, the special miniature motor required is costly, as are the batteries required to drive the motor.

To overcome the shortcomings, the present invention tends to provide a dental hygiene sprayer to mitigate or obviate the aforementioned problems.

### SUMMARY OF THE INVENTION

The main objective of the invention is to provide a dental hygiene sprayer that can provide a pulsating massage effect and is not driven by electrical power. The pulsating teeth sprayer has a body and a turbine rotor. The body is adapted to connect to a water source and has a handle and a spraying head. The turbine rotor is rotatably received in the body and has a semicircular ring, a semicircular top plate and multiple extension blades. The semicircular top cover is attached to the ring to construct a circle in cooperation with the semicircular ring. The extension blades are formed on and extend radially from the outer periphery of the ring and the top cover. Accordingly, the turbine rotor can be driven to rotate when water flows through the turbine rotor, and the water stream will be interrupted by the turbine rotor. Consequently, a pulsating stream is generated, and a pulsating massage effect is provided.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of a dental hygiene sprayer in accordance with the present invention;

FIG. 2 is a side plan view in partial cross section of the first embodiment of the sprayer in FIG. 1;

FIG. 3 is a bottom perspective view of the turbine rotor of the sprayer in FIG. 1;

FIG. 4 is a cross sectional top plan view of the first embodiment of the sprayer along line 4-4 in FIG. 2;

FIG. 5 is a perspective view of a washbasin with a sprayer in FIG. 1;

FIG. 6 is an operational side plan view of the sprayer in FIG. 1 showing that the sprayer is hung on a wall;

FIG. 7 is an exploded perspective view of a second embodiment of a dental hygiene sprayer in accordance with the present invention;

FIG. 8 is a side plan view in partial cross section of the sprayer in FIG. 6;

FIG. 9 is a cross sectional side plan view of the sprayer along line 9-9 in FIG. 8;

FIG. 10 is a side plan view in partial cross section of a third embodiment of a sprayer in accordance with the present invention;

FIG. 11 is a side plan view in partial cross section of a fourth embodiment of a sprayer in accordance with the present invention;

FIG. 12 is an exploded perspective view of a fifth embodiment of a sprayer in accordance with the present invention;

FIG. 13 is a side plan view in partial cross section of the sprayer in FIG. 12; and

FIG. 14 is an operational side plan view in partial cross section of a sixth embodiment of a sprayer in accordance with the present invention.

### DETAILED DESCRIPTION OF PREFERRED EMBODIMENT

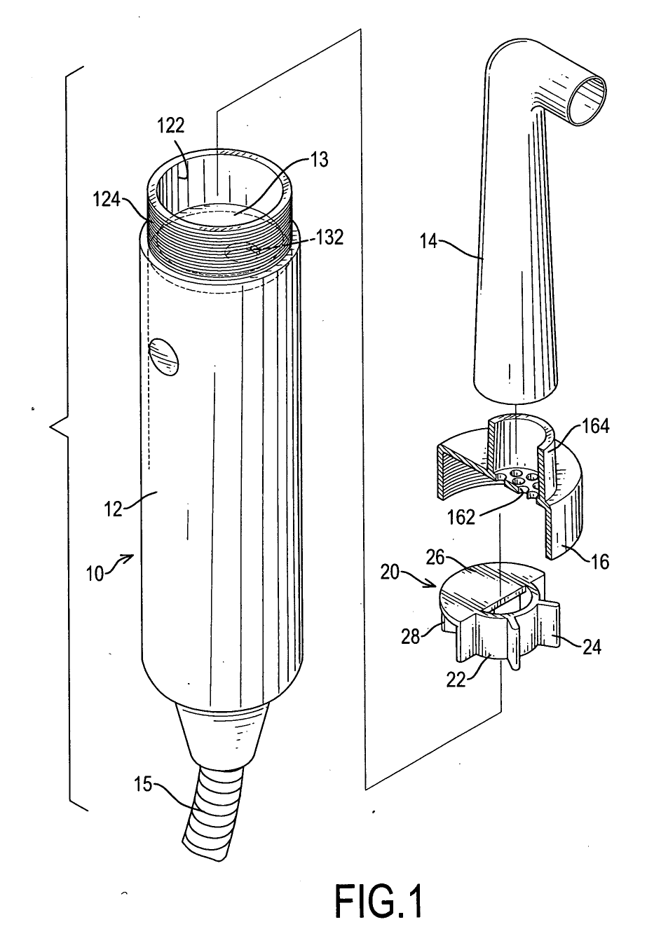

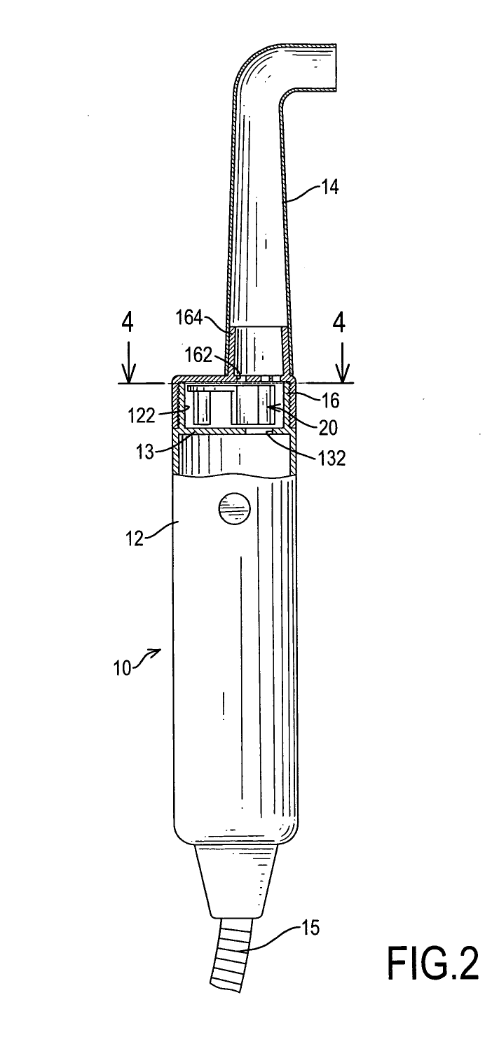

With reference to FIGS. 1 and 2, a first embodiment of a dental hygiene pulsating sprayer in accordance with the present invention comprises a body (10) and a turbine rotor (20). The body (10) comprises a handle (12), a cap (16) and a spraying head (14). The handle (12) has a first end and a second end, a first passage (not numbered), an outer thread (124) and a baffle (13). The first passage extends through the handle (12) from the first end to the second end. The baffle (13) is formed in the first passage near the first end so as to define a chamber (122) in the first end of the handle (12). A bore (132) is defined through the baffle (13) to communicate the chamber (122) with the rest of the first passage. The outer thread (124) is formed on the first end of the handle (12). The second end of the handle (12) is connected to a water source through a hose (15).

The cap (16) is attached to the first end of the handle (12) to close the chamber (122). The cap (16) has an inner thread (not numbered), one or multiple through holes (162) and a connecting tube (164). The inner thread is screwed with the outer thread (124) on the handle (12) to attach the cap (16) to the handle (12). The through holes (162) are defined in the cap (16) and communicate with the chamber (122) in the handle (12). The through holes (162) are arranged in a circle that aligns with the bore (132) in the baffle (13). The connecting tube (164) extends from the cap (16) and encloses the through holes (162).

The spraying head (14) is attached to the cap (16). The spraying head (14) is L-shaped and has a proximal end, a distal end and a second passage (not numbered). The second passage is defined through the spraying head (14) from the proximal end to the distal end. The proximal end is mounted onto the connecting tube (164) to attach the spraying head (14) to the cap (16), such that the second passage in the spraying head (14) communicates with the through holes (162) in the cap (16).

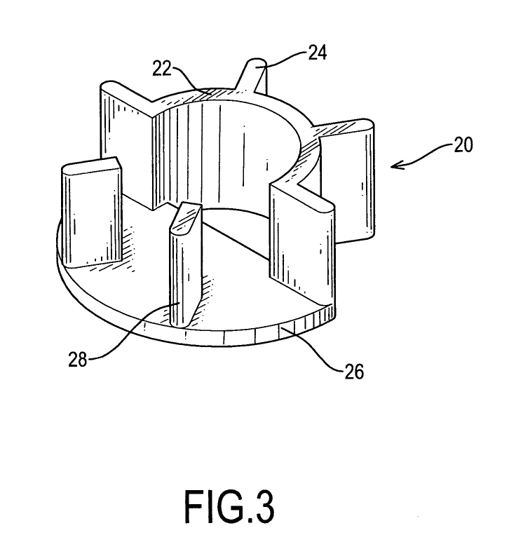

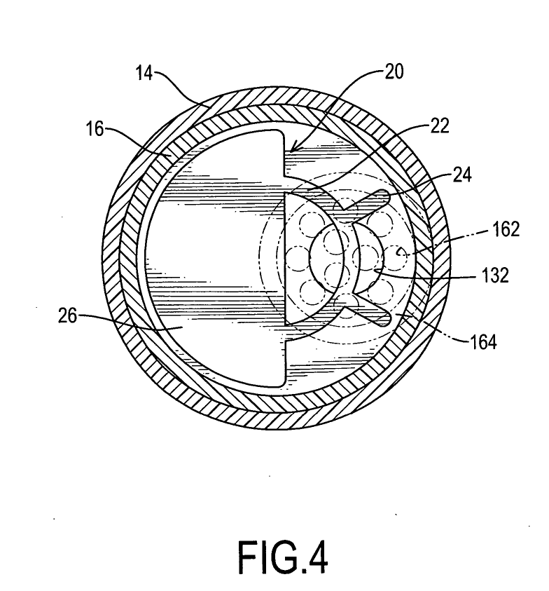

The turbine rotor (20) is rotatably received in the chamber (122) in the handle (12). With further reference to FIGS. 3 and 4, the turbine rotor (20) has a ring (22), multiple first extension blades (24), a top cover (26) and multiple second extension blades (28). The ring (22) is semicircular and has an outer periphery, and the first extension blades (24) are formed on and extend radially from the outer periphery of the ring (22). The top cover (26) is semicircular and is integrally formed with the ring (22) to construct a circle in cooperation with the semicircular ring (22). The second extension blades (28) are radially formed on the top cover (26) and correspond to the first extension blades (24) on the ring (22).

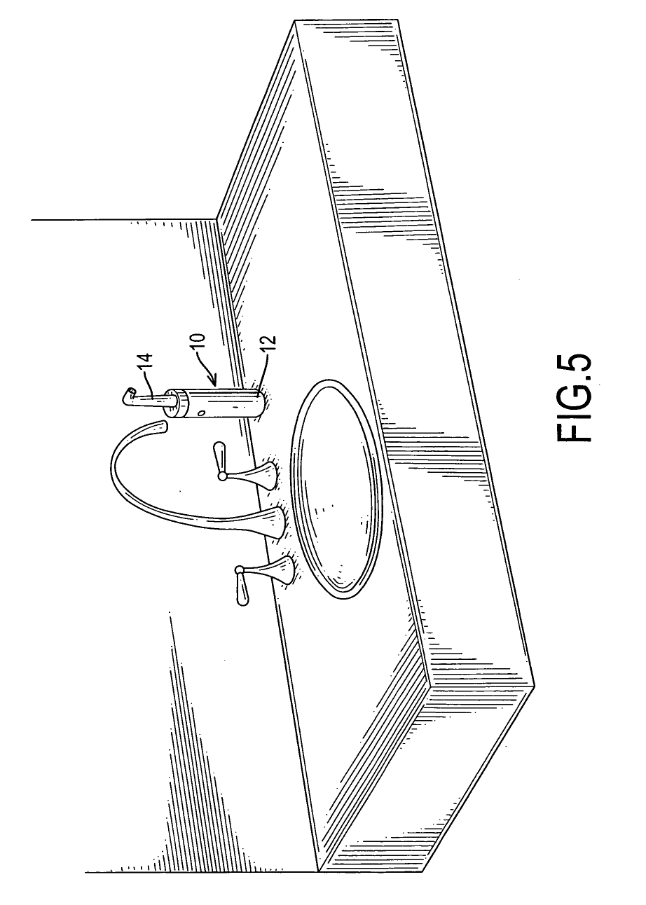

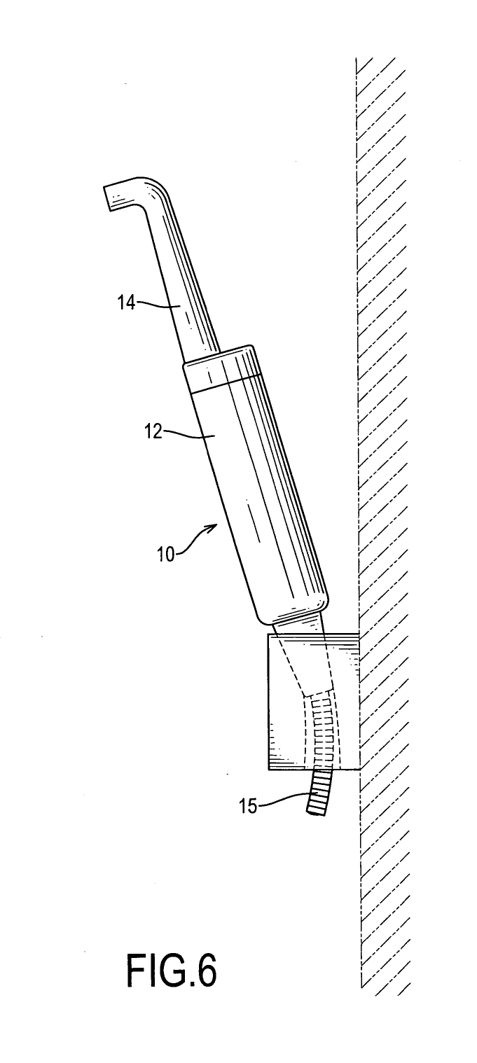

With further reference to FIGS. 5 and 6, the sprayer is connected to a water tap through the hose (15) and can mounted on a washbasin or attached on a wall as a spray head operating in a shower area. When the user turns on the water tap, the water will flow into the first passage in the handle (12) through the hose (15) and then flows into the chamber (122) through the bore (132). Water will spray out from the spraying head (14) through the through holes (162) in the cap (16) and the second passage in the spraying head (14) for cleaning teeth of the user. When water passes through the chamber (122), the water will impact on the blades (24,28) of the turbine rotor (20) so as to rotate the turbine rotor (20) in the chamber (122). Accordingly, the water stream passing through the chamber (122) will be interrupt by the top cover (26) when the turbine rotor rotates, such that a pulsating stream is made. Consequently, the discharged water from the spraying head (14) can provide a pulsating massage effect to the gum of the user when the user cleans teeth with the sprayer.

Because the sprayer is connected to a water system in a house and the turbine rotor (20) is driven to rotate by the water pressure, electrical power is not needed for the operation of the sprayer. To use the pulsating sprayer is convenient, safe and involves a low cost.

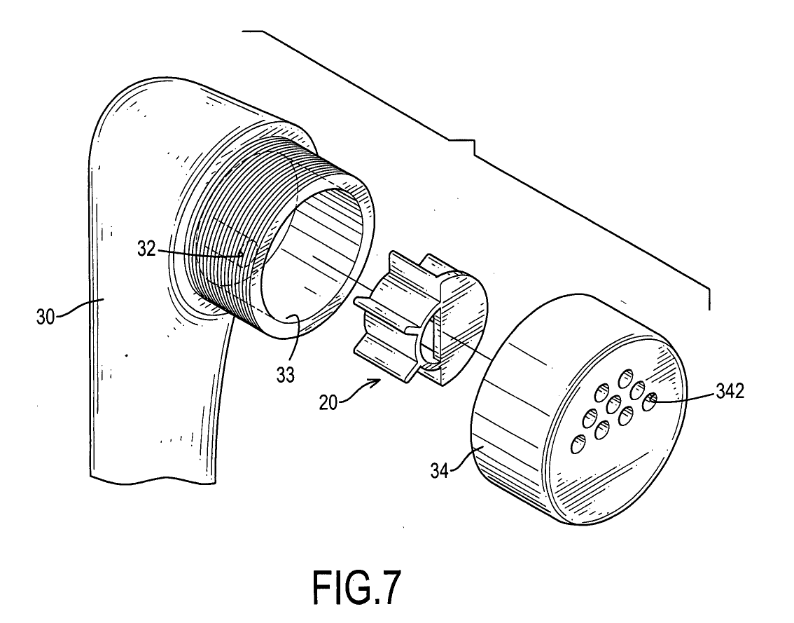

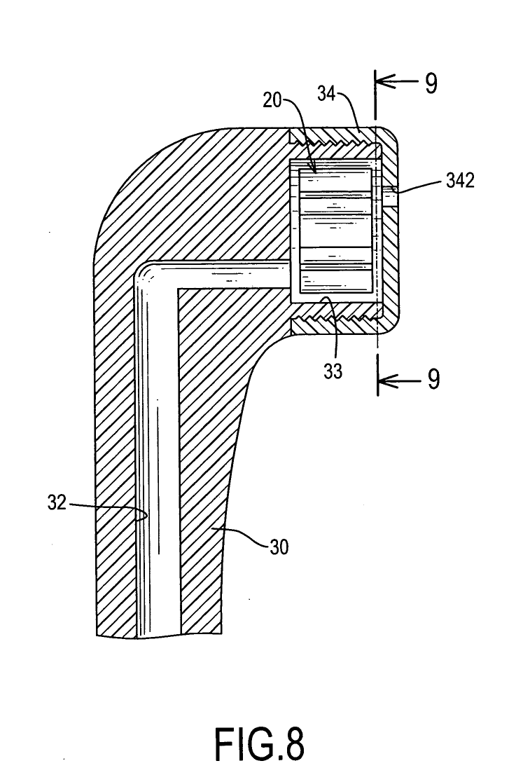

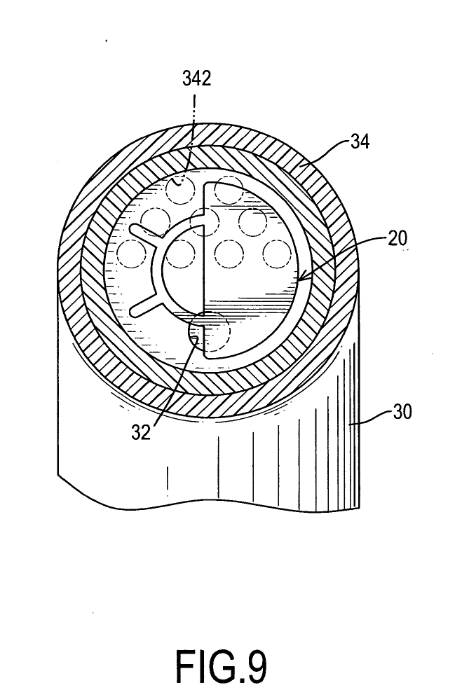

With reference to FIGS. 7 to 9, in another embodiment of a sprayer in accordance with the present invention, the sprayer comprises a body and a turbine rotor (20). The body has a handle (not shown) and a spraying head (30) attached to one end of the handle. The handle has a first passage and is connected to a water source through the hose as shown in FIG. 1. The spraying head (30) has a second passage (32) communicating with the first passage in the handle and a chamber (33). The chamber (33) is defined in the spraying head (30) at one end away from the handle and communicates with the second passage (32). In addition, a cap (34) is attached to the spraying head (30) to close the chamber (33), and the cap (34) has one or multiple through holes (342) communicating with the chamber (33).

The turbine rotor (20) is rotatably mounted in the chamber (33) in the spraying head (30). The turbine rotor (20) has a structure same as that of the turbine rotor shown in the first embodiment in FIG. 1 and has a ring, multiple first extension blades, a top cover and multiple second extension blades. In use, the sprayer can be connected to a water tap as the first embodiment.

When the user turns on the water tap, the water will flow into the chamber (33) through the passages (32) in the handle and the spraying head (30) and will spray out from the through holes (342) in the cap (34). When water passes through the chamber (33), the water will impact on the blades of the turbine rotor (20) so as to rotate the turbine rotor (20) in the chamber (33) so as to make a pulsating stream.

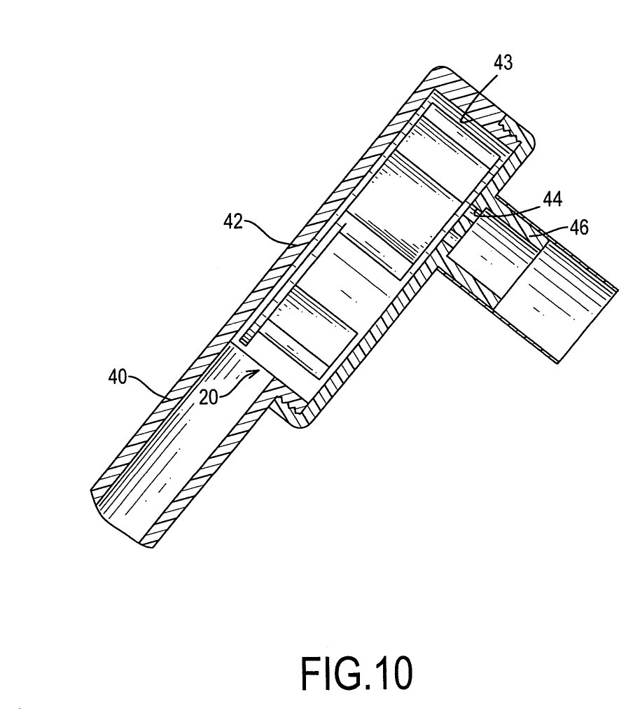

With reference to FIG. 10, in a third embodiment, the spraying head (40) has a closed end away from the handle (not shown). The spraying head (40) has a head portion (42), a cap (not numbered), one or multiple through holes (44) and a tube (46). The head portion (42) is circular and has define a chamber (43) defined in the head portion (42). The through holes (44) are defined in the cap attached to the head portion (42) and communicate with the chamber (43). The tube (46) extends from the cap and communicates with the through holes (44). The turbine rotor (20) is rotatably received in the chamber (43) in the circular head portion (42).

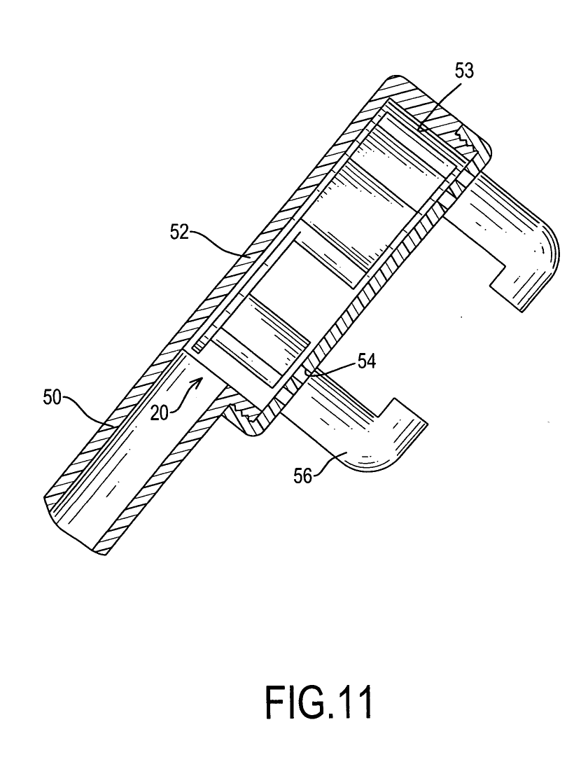

With reference to FIG. 11, in a fourth embodiment, the spraying head (50) has a closed end away from the handle (not shown). The spraying head (50) has a head portion (52), a cap, one or multiple through holes (54) and two tubes (56). The head portion (52) is circular and has a chamber (53) defined in the head portion (52). The through holes (54) are defined in the cap attached to the head portion (52) and communicate with the chamber (53). The through holes (54) are arranged respectively in two groups. The tubes (56) are mounted on and extend from the cap, and the tubes (56) respectively communicate with two groups of the through holes (54). The turbine rotor (20) is rotatably received in the chamber (53) in the circular head portion (52). In a preferred embodiment, each tube (56) is L-shaped and has an opening facing each other. Accordingly, the water spraying out from the openings of the tubes (56) can conveniently clean-both sides of teeth of the user.

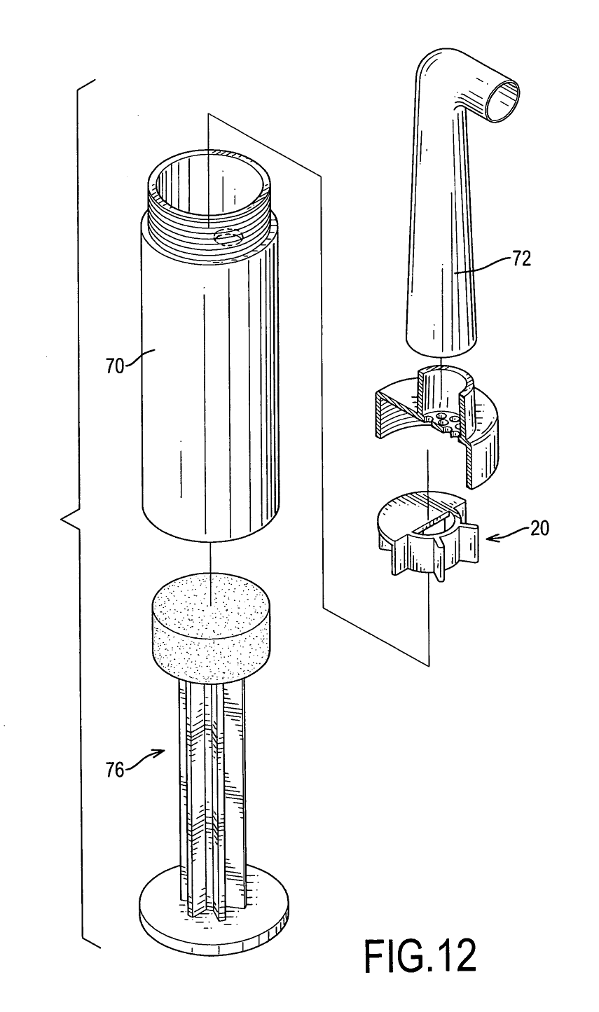

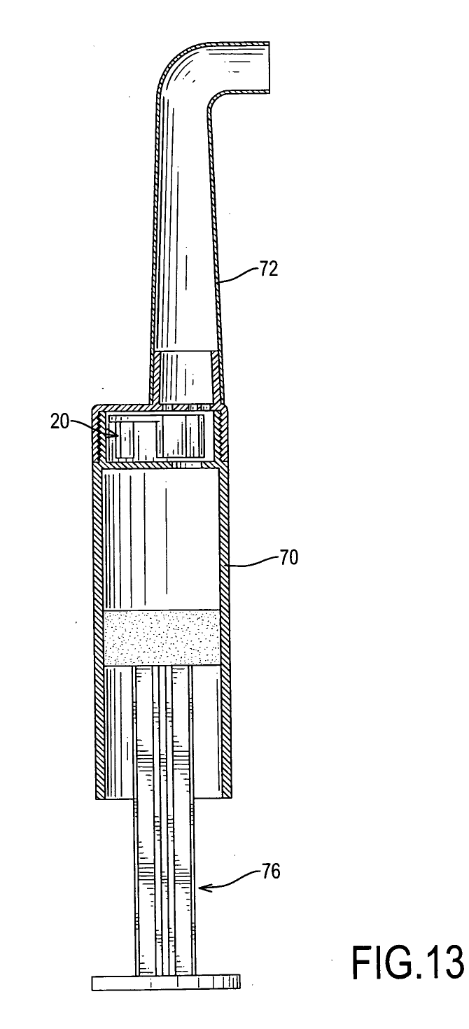

With reference to FIGS. 12 and 13, in a fifth embodiment, a plunger (76) is inserted into the handle (70) at one end far away from the spraying head (72). In such an arrangement, water is poured into the passage in the handle (70), and the plunger (76) is inserted into the handle (70). The water in the handle (70) will be forced into the chamber to drive the turbine rotor (20) rotation when the plunger (76) is pushed into the handle (70), and the water will discharge from the spraying head (72) with a pulsating effect provided by the turbine rotor (20). Thus, the device is portable and convenient for use away from home.

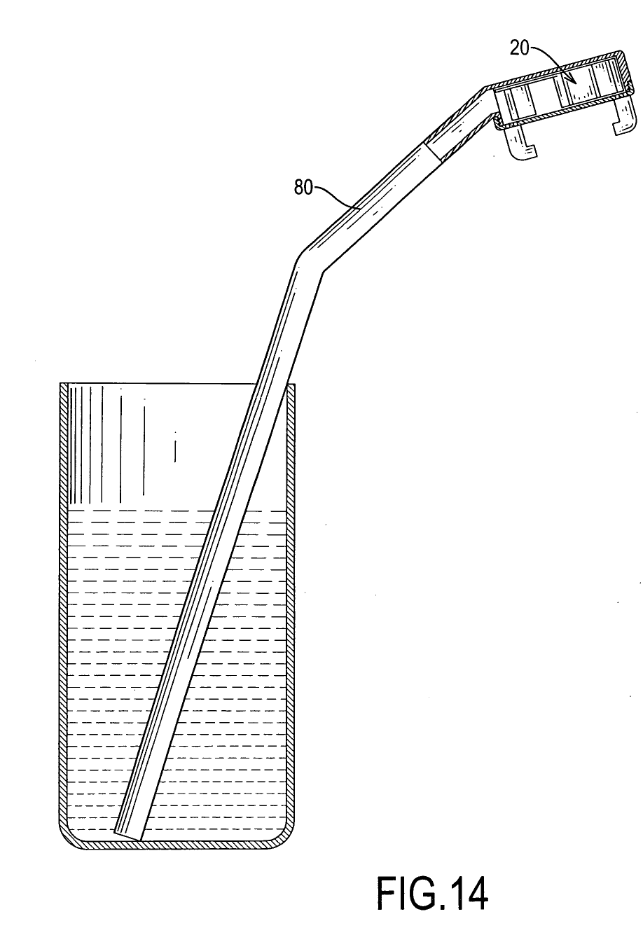

With reference to FIG. 14, in a sixth embodiment, the body (80) of the sprayer in accordance with the present invention can be a tubular body as a sucker. In operation of the embodiment, the body (80) is put into a cup containing water. The user keeps the head portion of the spraying head in mouth and sucks water through passage in the body (80). The water will spray out from the tubes mounted on the head portion of the spraying head for cleaning both sides of teeth of the user with a pulsating massage effect provided by the turbine rotor (20).

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A pulsating dental sprayer comprising:
a body adapted to connect to a water source and having a handle with a first passage defined through the handle; and
a spraying head connected to the handle and having a second passage communicating with the first passage; and
a turbine rotor rotatably received in the body and having a semicircular ring having an outer periphery;
multiple first extension blades formed on and extending radially from the outer periphery of the ring;
a semicircular top cover attached to the ring to construct a circle in cooperation with the semicircular ring; and
multiple second extension blades radially formed on the top cover and corresponding to the first extension blades on the ring.

2. The dental sprayer as claimed in claim 1, wherein the handle has a first end and a second end;
a baffle is formed in the first passage near the first end so as to define a chamber in the first end of the handle;
a bore is defined through the baffle to communicate with the chamber; and
the turbine rotor is rotatably received in the chamber in the handle.

3. The dental sprayer as claimed in claim 2 further comprising a cap attached to the first end of the handle to close the chamber and having at least one through hole defined in the cap and communicating with the chamber in the handle; and
a connecting tube extending from the cap and enclosing the through holes,
wherein the spraying head is attached to the connecting tube on the cap to be connected via the cap to the handle.

4. The dental sprayer as claimed in claim 3, wherein the through holes are arranged in a circle that concentrically aligns with the bore in the baffle.

5. The dental sprayer as claimed in claim 3, wherein the handle has an outer thread formed on the first end; and
the cap has an inner thread screwed with the outer thread on the handle to attach the cap to the handle.

6. The dental sprayer as claimed in claim 5 further comprising a plunger inserted into the handle at one end far away from the spraying head.

7. The dental sprayer as claimed in claim 1, wherein the spraying head is L-shaped.

8. The dental sprayer as claimed in claim 1, wherein the spraying head has a chamber defined in the spraying head at one end away from the handle and communicating with the second passage; and
the turbine rotor is rotatably received in the chamber in the spraying head.

9. The dental sprayer as claimed in claim 8 further comprising a cap attached to the spraying head to close the chamber in the spraying head and having at least one through hole communicating with the chamber.

10. The dental sprayer as claimed in claim 9 further comprising a tube extending from the cap and communicating with the at least on through hole.

11. The dental sprayer as claimed in claim 10, wherein the cap has multiple through holes defined in the cap and arranged respectively in two groups; and
two tubes are mounted on and extend from the cap and respectively communicate with the two groups of the through holes.

12. The dental sprayer as claimed in claim 11, wherein each respective tube is L-shaped and has an opening facing to each other.

13. The dental sprayer as claimed in claim 12, wherein the body is a tubular body formed as a sucking tube.
